(19) United States
(12) Patent Application Publication
(10) Pub. No.: US 2005/0137761 A1
(43) Pub. Date: Jun. 23, 2005

(54) Two-axis accelerometer used for train speed measurement and system using the same

(75) Inventor: Mihai Lungu, Thornhill (CA)

Correspondence Address: ALEX S. ESBER AND GEORGE A. MALLETTE, 2823 N. LEMON AVENUE, SARASOTA, FL, 34234, US

(73) Assignee: ALCATEL

(21) Appl. No.: 10/740,860

(22) Filed: Dec. 22, 2003

(51) Int. Cl. G06F 7/00

(52) U.S. Cl. 701/20

(57) ABSTRACT

The present invention is a two-axis accelerometer, and a system in which the accelerometer is incorporated, to measure the acceleration/deceleration of train, while independently dynamically measuring the grade on which the train is traveling. The two-axis accelerometer is mounted in a longitudinal plane at a mounting angle δ, and through measuring the train's acceleration and gravity components along an axis aₓ and a_{y}, the accelerometer provides a measurement of both the acceleration/deceleration of a train, while also providing an independent dynamic measurement of the grade on which the train is traveling.

### BACKGROUND OF THE INVENTION

1. Field of the Invention

The present invention generally relates to the field of two-axis accelerometers, in particular the present invention is directed to two-axis accelerometers used for train speed measurement.

2. Discussion of Related Art

Currently, a need exists for a train speed measurement system that accurately measures the acceleration and grade of a locomotive assembly. Existing train speed measurement systems use a one-axis accelerometer including a mechanical sensor arrangement to provide velocity, acceleration, adhesion, and speed sensor tracking. However, due to the dependence, in these systems, on the acceleration measurements upon a rail-wheel adhesion factor, the current systems must compensate for the loss of adhesion during the measurement phase of operations.

The loss of rail-to-wheel adhesion during the course of train operations renders the measuring of speed parameters difficult and unreliable when utilizing conventional systems. Because measured acceleration is dynamically biased with the current grade, a need exists to properly compensate when taking speed measurements, requiring additional algorithms for obtaining an accurate measurement of the necessary data. These factors culminate in a train speed measurement system that has an estimated error measurement of more than 10%.

### SUMMARY OF THE INVENTION

The present invention is directed to two-axis accelerometers used for train speed measurement, which address the problems discussed above. Specifically, the present invention is a two-axis accelerometer which separates the train's grade component from the train's acceleration component. This configuration and structure allows for a tighter tracking of train's primary speed sensor, a more reliable detection of the loss of adhesion and more accurate compensation during loss of adhesion.

In the present invention, a two-axis accelerometer is mounted in a longitudinal plane at an angle to a reference plane. The two-axis accelerometer measures the train's acceleration and gravity components along both an x and y axis, with respect to the mounted accelerometer. In using the two-axis accelerometer of the present invention, the train's acceleration is a function of the mounting angle and actual acceleration measurements.

The two-axis accelerometer, of the present invention, provides a train acceleration measurement that is independent of the grade on which the train is traveling, while determining a dynamic measurement of the grade.

### BRIEF DESCRIPTION OF THE DRAWINGS

The advantages, nature and various additional features of the invention will appear more fully upon consideration of the illustrative embodiment of the invention which is schematically set forth in the drawing, in which:

FIG. 1 is a graphical representation of a coordinate system and vectors for a train acceleration/deceleration and grade measurement with a two-axis accelerometer of the present invention;

FIG. 2 is a diagrammatical representation of a train acceleration and grade monitoring system incorporating a two-axis accelerometer of the present invention.

### DETAILED DESCRIPTION OF THE INVENTION

The present invention will be explained in further detail by making reference to the accompanying drawings, which do not limit the scope of the invention in any way.

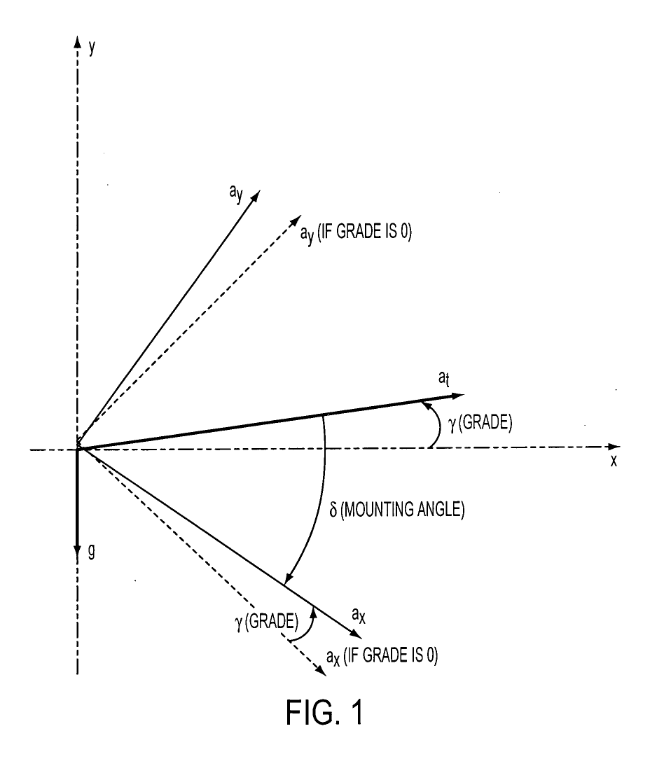

Turning now to FIG. 1, this Figure depicts a vector representation of the train acceleration at with respect to a normal reference axis x-y. In the embodiment of the present invention, the two-axis accelerometer is mounted in a longitudinal plane, with respect to the train, and at an angle δ with respect to the x-axis (i.e. horizontal). The y axis denotes a vertical reference while the x axis denotes a horizontal reference. It is noted that the angle δ of mounting can be at any point between 0° to 90°, but is preferably within the range of 35° to 55°, and most preferably at an angle of 45°.

When the train is accelerating/decelerating and/or is on a graded portion of the track, the two-axis accelerometer measures the train's acceleratioti/deceleration and gravity g components along both the aₓ and a_{y} axis of the accelerometer, as shown in FIG. 1. Based on these measurements, obtained from the two-axis accelerometer, both the acceleration/deceleration at and the grade γ of the train can be calculated. The equations that can be used to perform these calculations are as follows:
aₜ=aₓcosδ+a_{y}±\sqrt{g²−(aₓsinδ−a_{y}cosδ)²} (1)

$$γ = arctg ( \frac{{a}_{t} sin δ - {a}_{y}}{{a}_{t} cos δ - {a}_{x}} ) - δ - \frac{π}{2} \qquad ( 2 )$$

As shown in the above equations the acceleration aₜ of the train is dependent only on actual measurements taken by the two-axis accelerometer measurements and known constants, such as the mounting angle δ and gravity g. Additionally, by using the above equations the current grade γ can be dynamically measured.

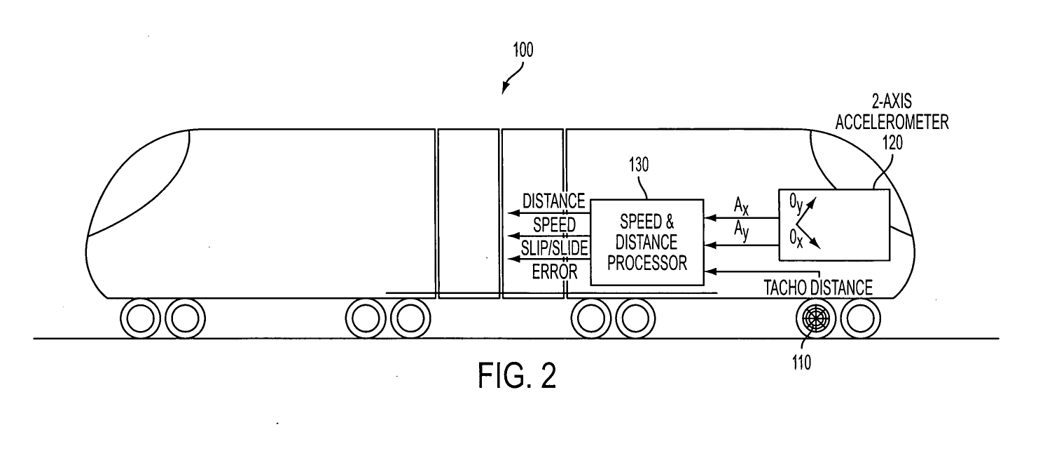

FIG. 2 depicts, train acceleration and grade monitoring system incorporating a two-axis accelerometer of the present invention, shown on a train 100. As indicated above, the system uses a two-axis accelerometer 120 which is mounted in a longitudinal plane of the train 100. The mounting of the two-axis accelerometer 120 is in accordance with the required mounting standards for the particular accelerometer 120 used, and preferably should be in a vertical orientation, as shown in FIG. 2. An example of a two-axis accelerometer which can be used is the ADXL202 from Analog Devices.

In a preferred embodiment, the two-axis accelerometer 120 uses iMEMS technology to integrate two accelerometers which are positioned 90 degrees, with respect to teach other, and provides outputs proportional to the tilt of each of the integrated accelerometers. The accelerometer 120 has a plurality of outputs to provide the needed data. Two of the outputs, one each for the X and Y directions, are in PWM format, where the output has a nominal 50% duty cycle for a 0 degree tilt. These outputs are used in a microcontroller based system. Two additional outputs, again one each for the X and Y directions, are in analogue format, providing a DC voltage which is proportional to the tilt.

As shown in FIG. 2, the system for monitoring the train acceleration uses a speed and distance processor card 130 and two sensors, the two-axis accelerometer 120 and a tachometer 110. The two-axis accelerometer 120 is mounted in a longitudinal plane of the train 100 with the Ox and Oy axis rotated, most preferably, at 45 degrees from the horizontal and vertical axis, respectively.

The two PWM outputs from the two-axis accelerometer 120 are coupled to the processor card 130, and the processor card 130 determines, from these inputs, the true acceleration of the train 100, eliminating the grade component. This determination is made in accordance with the previous discussion, regarding FIG. 1.

Additionally, the processor card 130 receives a signal from the tachometer 110, which can be a digital tachometer. The tachometer 110 is mounted on an axle or wheel of the train 100. The tachometer 110 outputs a predefined number of pulses for each complete rotation of the axle, (or wheel depending on the configuration). Thus, the tachometer 110 provides the information on the distance traveled by the train 100 under normal conditions, i.e. when the wheel-to-rail adhesion is sufficient and no slipping or sliding is occurring.

With the above information, the processor card 130 determines the speed of the train and then differentiates the distance traveled in time, using the tachometer 110 input, and integrates the acceleration in time, using the acceleration input from the accelerometer 120. Then, the two speed values (from each of the sensors 110 and 120) are continuously cross-compared to ensure that the two are in agreement, within a predetermined or defined tolerance. If the tolerance is exceeded (i.e. the difference in speed values between the sensors 120 and 110 is too great) a slippage or sliding condition is detected and the processor card 130 compensates the train's 100 dynamics values. Stated differently, when the difference between the values from the two sensors 110 and 120 is over a threshold the card 130 determines that the train 100 is slipping or sliding, and then the card 130 corrects the dynamic values (i.e. speed and distance traveled) of the train 100. This permits the train's systems to accurately monitor the train's progress and data during conditions or times when the train 100 has lost adhesion with the rails.

It is noted that although the above embodiment is discussed within the context of monitoring the dynamic values of a train, it is understood and contemplated that the above described system can be used on additional modes of transportation, including passenger vehicles, freight vehicles and the like.

It is of course understood that departures can be made from the preferred embodiments of the invention by those of ordinary skill in the art without departing from the spirit and scope of the invention that is limited only by the following claims.

1. A system for monitoring a dynamic value of a vehicle, comprising:
a two-axis accelerometer having a first axis and a second axis and at least one output for each of said first axis and said second axis; and
a processor coupled to both of said outputs for said first and second axis, wherein said processor uses data from each of said outputs to determine at least one of the speed, acceleration, grade, slippage or sliding of said vehicle.

2. A system in accordance with claim 1, wherein said first axis and said second axis are perpendicular to each other.

3. A system in accordance with claim 1, wherein said two-axis accelerometer is positioned in a longitudinal plane with respect to said vehicle.

4. A system in accordance with claim 2, wherein said two-axis accelerometer is positioned in a vertical place with respect to said vehicle.

5. A system in accordance with claim 1, wherein said two-axis accelerometer is mounted such that an angle between at least one of the first and second axis and a horizontal plane is within the range of 35 to 55 degrees.

6. A system in accordance with claim 1, wherein said two-axis accelerometer is mounted such that an angle between at least one of the first and second axis and a horizontal plane is 45 degrees.

7. A system in accordance with claim 1, further comprising a tachometer which provides tachometer data to said processor.

8. A system in accordance with claim 7, wherein said processor uses said tachometer data to determine a speed of said vehicle.

9. A system in accordance with claim 7, wherein said processor compares said tachometer data with said data from said outputs to determine at least one of the speed, acceleration, slippage and sliding if said vehicle.

10. A system in accordance with claim 7, wherein said tachometer is mounted onto an axle of said vehicle.

11. A system in accordance with claim 1, wherein said vehicle is a train.

12. A system in accordance with claim 1, wherein said processor determines the acceleration of said vehicles based on said data, wherein said determination includes determining the grade of said vehicle.

13. A system for monitoring a dynamic value of a train, comprising:
a two-axis accelerometer having a first axis and a second axis and at least one output for each of said first axis and said second axis;
a tachometer; and
a device which determines at least one of the speed and acceleration of said train coupled to said outputs of said two-axis accelerometer and said tachometer;
wherein said device uses data from each of said outputs and said tachometer to determine at least one of the speed, acceleration, grade, slippage or sliding of said train.

14. A system in accordance with claim 13, wherein said first axis and said second axis are perpendicular to each other.

15. A system in accordance with claim 13, wherein said two-axis accelerometer is positioned in a longitudinal plane with respect to said train.

16. A system in accordance with claim 15, wherein said two-axis accelerometer is positioned in a vertical place with respect to said train.

17. A system in accordance with claim 13, wherein said two-axis accelerometer is mounted such that an angle between at least one of the first and second axis and a horizontal plane is within the range of 35 to 55 degrees.

18. A system in accordance with claim 13, wherein said two-axis accelerometer is mounted such that an angle between at least one of the first and second axis and a horizontal plane is 45 degrees.

19. A system in accordance with claim 7, wherein said device compares said tachometer data with said data from said outputs to determine at least one of the speed, acceleration, slippage or sliding of said train.

20. A system in accordance with claim 13, wherein said tachometer is mounted onto an axle of said train.

21. A system in accordance with claim 13, wherein said device determines the acceleration of said train based on said data from said tachometer and said two-axis accelerometer, wherein said determination includes determining the grade of said vehicle.

22. A system in accordance with claim 13, wherein at least one of an actual speed and acceleration are determined by said device based on a difference between said data from said tachometer and said data from said two-axis accelerometer.
